(19) United States
(12) Patent Application Publication
(10) Pub. No.: US 2018/0107823 A1
(43) Pub. Date: Apr. 19, 2018

(54) Programmable Hardware Security Counters

(71) Applicant: QUALCOMM Incorporated, San Diego, CA (US)

(72) Inventors: Ramin Samadani, Menlo Park, CA (US); Yin Chen, Campbell, CA (US); Joel Galenson, Santa Clara, CA (US); Nayeem Islam, Palo Alto, CA (US)

(21) Appl. No.: 15/432,516

(22) Filed: Feb. 14, 2017

Related U.S. Application Data
(60) Provisional application No. 62/408,245, filed on Oct. 14, 2016.

(51) Int. Cl. G06F 21/52; G06F 9/30

(52) U.S. Cl. CPC G06F 21/52; G06F 9/30098; G06F 9/30145

(57) ABSTRACT

Embodiments include computing devices and methods implemented by computing devices for using programmable hardware security counters for detecting malicious behavior. Various embodiments may include tracking the value of hardware instruction pointers, such as pointers tracking the memory address of each executing instruction. The computing device may identify a start and end of contiguous instruction segments using the tracked instruction pointer. For example, the computing device may analyze changes in value of the instruction pointer to detect “jumps” or large changes in the memory address of executing instructions. Based, at least in part, on the identified instruction segments, the computing device may determine whether the instruction segments represent malicious behavior. If the instruction segments represent malicious behavior, the computing device may terminate the requesting software application.

### CROSS-REFERENCE TO RELATED APPLICATIONS

This application claims the benefit of priority under 35 U.S.C. § 119(e) to U.S. Provisional Application No. 62/408,245 entitled “Programmable Hardware Security Counters” filed Oct. 14, 2016, the entire contents of which are hereby incorporated by reference.

### BACKGROUND

Hackers use a variety of strategies for attacking computing devices, including mobile devices. Many strategies involve attempts to identify the memory layout of an application so that known vulnerabilities in system services can be exploited by knowing where the services are located in memory. Such attacks may embody “control hijack attacks” that target and take control of system services or privileged applications on a device. Attackers often try to obtain a shell or try to execute malicious code, e.g., code that can steal private data and send it server remote computer. Control hijacking attacks often use return oriented programming (ROP). The goal of ROP attacks is privilege escalation and resulting access. Such attacks often employ brute force tactics in which an attacker exhaustively explores the process address space to find vulnerable or gadget code/data locations. After overwriting a code pointer, attackers execute multiple small sequences of normal instructions (gadgets) to take control. These gadgets are normal code sequences, but the attacker executes them out of order and branch between them.

Existing software defenses add a performance penalty, and sometimes require recompiling from source code, which is not always available. Existing hardware defenses rely on architecture specific performance counters, which are meant for monitoring and diagnosing processor performance, and are inefficient in defending against ROP attacks. To detect and prevent ROP attacks, recent techniques leverage hardware trace counters that track recent branches. Trace counters are used to detect branches to normally impossible locations or many very short instruction sequences. But these counters are either very slow, e.g., branch trace store (BTS) counters, or can only track the N most recent branches, e.g., last branch record (LBR) counters. Attackers evade these defenses by inserting long gadgets that do nothing, which overflows the LBR counters and hides the short gadgets.

Other defenses techniques use hardware performance counters, e.g., translation look aside buffer (TLB) miss counters and cache miss counters. These performance counters look for architectural features like TLB/cache misses, wrongly predicted branches, etc. However, the performance counters must be polled periodically. If the polling period is long/high, short attacks will get lost in the noise. If the polling period is short/low, the overhead will be very high.

### SUMMARY

Various embodiments include methods, hardware components, and processor implementing the methods of detecting malicious behavior in a computing device using the hardware counters. Various embodiments may include tracking a value of an instruction pointer, identifying a start and end of contiguous instruction segments using tracked values of the instruction pointer, determining whether patterns of the instruction segments represent malicious behavior based, at least in part, on the identified start and end of the instruction segments, and terminating execution of an application in response to determining that the patterns of the instruction segments represent malicious behavior.

In various embodiments tracking the value of the instruction pointer may be performed in response to detecting an occurrence of a trigger event.

In various embodiments identifying the start and the end of the contiguous instruction segments using tracked values of the instruction pointer may include storing the instruction pointer value of a beginning instruction as the start of a contiguous instruction segment, calculating a change in the value of the instruction pointer between contiguous instructions, determining whether the calculated change exceeds a threshold, and storing the instruction pointer value of a last instruction prior to the calculated change exceeding the threshold as an end of the contiguous instruction segment and storing the instruction pointer value after the calculated change exceeding the threshold as a start of another contiguous instruction segment in response to determining that the calculated change exceeds the threshold. In such embodiments, the operations may be repeated until all contiguous instruction segments within a period of time are identified.

In various embodiments, determining whether the instruction segments represent malicious behavior based, at least in part, on the identified start and end of the instruction segments may include analyzing instruction parameters of the contiguous instruction segments, generating a behavior vector based, at least in part on, the analyzed instruction parameters, providing the generated behavior vector to a classifier model, determining based, at least in part, on a result of the classifier model whether the behavior vector represents malicious behavior, and determining that the patterns of the instruction segments represent malicious behavior in response to determining that the behavior vector represents malicious behavior.

Such embodiments may further include determining whether one or more of the instruction parameters meet a parameter threshold, and determining that the patterns of the instruction segments do not represent malicious behavior in response to determining that none of the instruction parameters meet the parameter threshold. In such embodiments, the instruction parameters may include a length of contiguous instruction segments. In such embodiments, the instruction parameters may include a transition of the register addresses of instructions within each instruction segment. In such embodiments, the instruction parameters may include the transition of the register addresses of instructions within each instruction segment between user code and a library.

In some embodiments, the operations of tracking the value of the instruction pointer and identifying the start and end of contiguous instruction segments using tracked values of the instruction pointer pay be performed within a hardware component.

Further embodiments include a hardware module implemented within a computing device that may include an instruction pointer tracking circuit configured to obtain a value of the instruction pointer of a processor, an analysis circuit configured to receive the value of the instruction pointer and identify a start and end of contiguous instruction segments using the values of the instruction pointer and output the start and end values of the instruction pointer for instruction segments, a buffer circuit, and a filter circuit configured to receive the start and end values of the instruction pointer for instruction segments, apply filter criteria to the start and end values, and output to the buffer circuit any start and end values of the instruction pointer for instruction segments that satisfy the filter criteria. In such embodiments, the buffer circuit may be configured to signal the processor when filtered start and end values of the instruction pointer for instruction segments are available for analysis.

Further embodiments include a processor that may include a hardware module that includes an instruction pointer tracking circuit configured to obtain a value of the instruction pointer of the processor, an analysis circuit configured to receive the value of the instruction pointer and identify a start and end of contiguous instruction segments using the values of the instruction pointer, and output the start and end values of the instruction pointer for instruction segments, a buffer circuit, and a filter circuit configured to receive the start and end values of the instruction pointer for instruction segments, apply filter criteria to the start and end values, and output to the buffer circuit any start and end values of the instruction pointer for instruction segments that satisfy the filter criteria. In such embodiments, the buffer circuit may be configured to signal the processor when filtered start and end values of the instruction pointer for instruction segments are available for analysis, and the processor may be configured to analyze the filtered start and end values of the instruction pointer to determine whether patterns of the instruction segments represent malicious behavior based, at least in part, on the filtered start and the end of the instruction segments, and terminate execution of an application in response to determining that the patterns of the instruction segments represent malicious behavior.

In various embodiments, the instruction pointer tracking circuit may be configured to obtain the value of the instruction pointer of the processor in response to detecting an occurrence of a trigger event. In some embodiments, the analysis circuit may be configured to receive the value of the instruction pointer and identify a start and end of contiguous instruction segments using the values of the instruction pointer, and output to the buffer circuit any start and end values of the instruction pointer for instruction segments that satisfy the filter criteria by storing the instruction pointer value of a beginning instruction as the start of a contiguous instruction segment, calculating a change in the value of the instruction pointer between contiguous instructions, determining whether the calculated change exceeds a threshold, and storing the instruction pointer value of a last instruction prior to the calculated change exceeding the threshold as an end of the contiguous instruction segment and storing the instruction pointer value after the calculated change exceeding the threshold as a start of another contiguous instruction segment in response to determining that the calculated change exceeds the threshold.

In various embodiments, the processor may be further configured to determine whether the instruction segments represent malicious behavior based, at least in part, on the identified start and end of the instruction segments by analyzing instruction parameters of the contiguous instruction segments generating a behavior vector based, at least in part on, the analyzed instruction parameters, providing the generated behavior vector to a classifier model, determining based, at least in part, on a result of the classifier model whether the behavior vector represents malicious behavior, and determining that the patterns of the instruction segments represent malicious behavior in response to determining that the behavior vector represents malicious behavior. In such embodiments, the processor may be further configured to determine whether one or more of the instruction parameters meet a parameter threshold, and determine that the patterns of the instruction segments do not represent malicious behavior in response to determining that none of the instruction parameters meet the parameter threshold. In such embodiments, the instruction parameters may include a length of contiguous instruction segments. In such embodiments, the instruction parameters may include a transition of the register addresses of instructions within each instruction segment. In such embodiments, the instruction parameters may include the transition of the register addresses of instructions within each instruction segment between user code and a library.

Further embodiments include a non-transitory processor-readable storage medium having stored thereon processor-executable instructions configured to cause a processor to perform operations of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating a computing device suitable for implementing various embodiments.

FIG. 2 is a component block diagram illustrating an example multi-core processor suitable for implementing various embodiments.

FIG. 3 is a system flow diagram illustrating implementations of programmable hardware counters for implementing various embodiments.

FIG. 4A is graph diagram illustrating example normal instruction segments according to various embodiments.

FIG. 4B is graph diagram illustrating example malicious instruction segments according to various embodiments.

FIG. 5 is a process flow diagram illustrating a method for implementing programmable hardware security counters according to various embodiments.

FIG. 6 is a process flow diagram illustrating a method for implementing tracking of hardware instruction counters according to various embodiments.

FIG. 7 is a process flow diagram illustrating a method for implementing identifying instruction segments using a hardware instruction pointer according to various embodiments.

FIG. 8 is a process flow diagram illustrating a method for implementing determining whether instruction segments represent malicious behavior according to various embodiments.

FIG. 9 is component block diagram illustrating an example mobile computing device suitable for use with various embodiments.

FIG. 10 is component block diagram illustrating an example mobile computing device suitable for use with various embodiments.

FIG. 11 is component block diagram illustrating an example server suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

Various embodiments include methods, and systems and devices implementing such methods for implementing programmable hardware security counters for evaluating software executing in the computing device. Various embodiments may include tracking the value of hardware instruction pointers, such as pointers tracking the memory address of each executing instruction. The computing device may identify a start and end of contiguous instruction segments using the tracked instruction pointer. For example, the computing device may analyze the changes in value of the instruction pointer to detect “jumps” or large changes in the memory address of executing instructions. Based, at least in part, on the identified instruction segments, the computing device may determine whether the instruction segments represent malicious behavior such as ROP attacks. If the instruction segments do represent malicious behavior, the computing device may terminate the requesting software application.

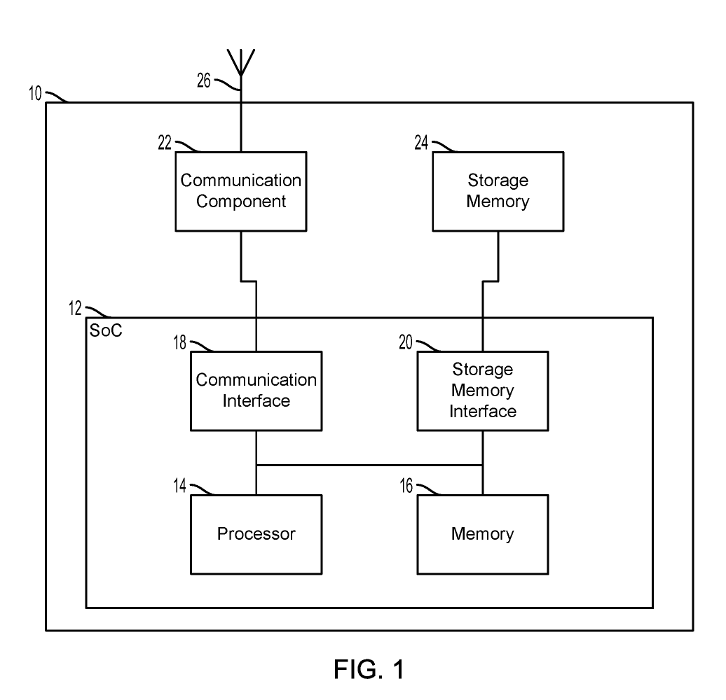

FIG. 1 illustrates a computing device 10 suitable for use with the various embodiments. The computing device 10 may include a system-on-chip (SoC) 12 with a processor 14, a memory 16, a communication interface 18, and a storage memory interface 20. The computing device may further include a communication component 22 such as a wired or wireless modem, a storage memory 24, and an antenna 26 for establishing a wireless communication link. The processor 14 may include any of a variety of hardware cores, for example a number of processor cores.

The term “system-on-chip” (SoC) is used herein to refer to a set of interconnected electronic circuits typically, but not exclusively, including a hardware core, a memory, and a communication interface. A hardware core may include a variety of different types of processors, such as a general purpose processor, a central processing unit (CPU), a digital signal processor (DSP), a graphics processing unit (GPU), an accelerated processing unit (APU), an auxiliary processor, a single-core processor, and a multi-core processor. A hardware core may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

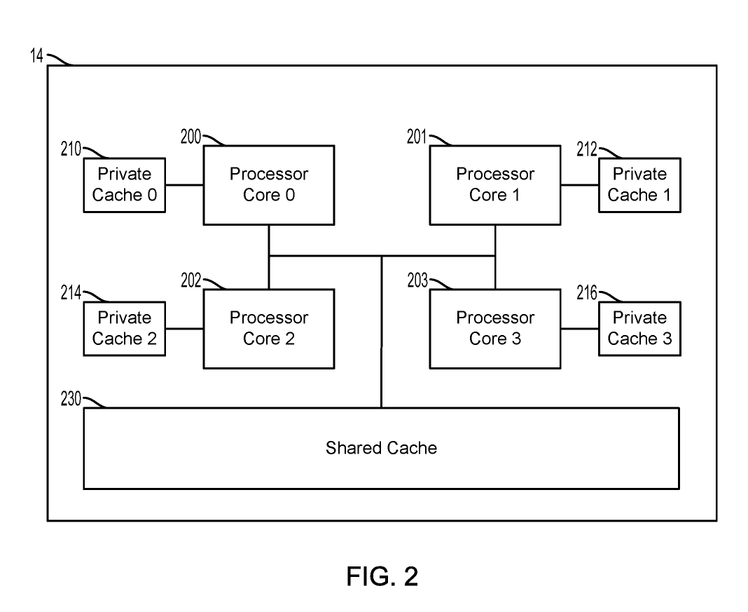

The SoC 12 may include one or more processors 14. The computing device 10 may include more than one SoCs 12, thereby increasing the number of processors 14 and processor cores. The computing device 10 may also include processors 14 that are not associated with the SoC 12. Individual processors 14 may be multi-core processors (e.g., as described below with reference to FIG. 2). The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, or cache memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a miss, because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 in response to execution of a function may result from a memory access request to another memory 16 or storage memory 24, and the data or processor-executable code may be loaded to the memory 16 for later access.

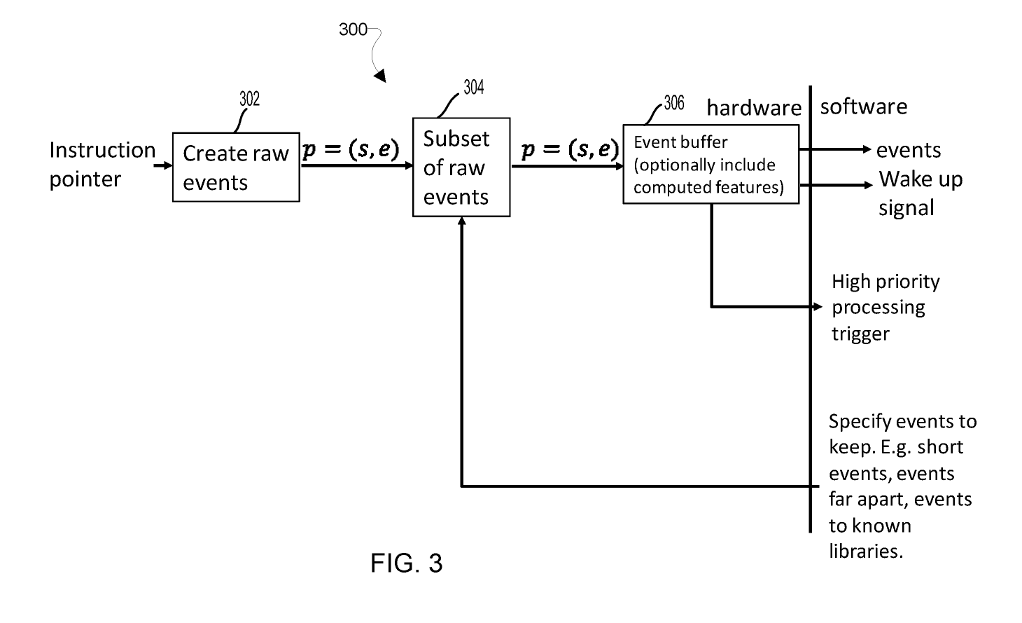

The memory 16 may be configured to store raw data, at least temporarily, that is loaded to the memory 16 from a raw data source device, such as a sensor or subsystem. Raw data may stream from the raw data source device to the memory 16 and be stored by the memory until the raw data may be received and processed by a machine learning accelerator (e.g., as described further herein with reference to FIGS. 3-9).

The storage memory interface 20 and the storage memory 24 may work in unison to allow the computing device 10 to store data and processor-executable code on a non-volatile storage medium. The storage memory 24 may be configured much like embodiments of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be differently arranged and/or combined while still serving the necessary functions. Moreover, the computing device 10 may not be limited to one of each of the components, and multiple instances of each component may be included in various configurations of the computing device 10.

FIG. 2 illustrates a multi-core processor 14 suitable for implementing an embodiment. With reference to FIGS. 1-2, the multi-core processor 14 may have a plurality of homogeneous or heterogeneous processor cores 200, 201, 202, 203. The processor cores 200, 201, 202, 203 may be homogeneous in that, the processor cores 200, 201, 202, 203 of a single processor 14 may be configured for the same purpose and have the same or similar performance characteristics. For example, the processor 14 may be a general purpose processor, and the processor cores 200, 201, 202, 203 may be homogeneous general purpose processor cores. Alternatively, the processor 14 may be a graphics processing unit or a digital signal processor, and the processor cores 200, 201, 202, 203 may be homogeneous graphics processor cores or digital signal processor cores, respectively. For ease of reference, the terms “processor” and “processor core” may be used interchangeably herein.

The processor cores 200, 201, 202, 203 may be heterogeneous in that, the processor cores 200, 201, 202, 203 of a single processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar embodiments, the SoC 12 may include a number of homogeneous or heterogeneous processors 14.

In some embodiments, the multi-core processor 14 may include four processor cores 200, 201, 202, 203 (i.e., processor core 0, processor core 1, processor core 2, and processor core 3). For ease of explanation, the examples herein may refer to the four processor cores 200, 201, 202, 203. However, the four processor cores 200, 201, 202, 203 described herein are merely provided as an example and in no way are meant to limit the various embodiments to a four-core processor system. The computing device 10, the SoC 12, or the multi-core processor 14 may individually or in combination include fewer or more than the four processor cores 200, 201, 202, 203 illustrated and described herein.

FIG. 3 illustrates circuitry 300 for implementing programmable hardware security counters to an embodiment. With reference to FIGS. 1-3, the circuitry 300 may be implemented as dedicated hardware that interfaces with memory registers, and sends data to and receives data from software executing in a processor (e.g., the processor 14 in FIGS. 1 and 2).

In various embodiments, the circuitry 300 in hardware block 302 may monitor/track the current value of a hardware instruction pointer associated with a currently executing instruction, storing the value/address of the instruction pointer when a contiguous section of code begins execution, denoted as value s, and storing the value/address of the instruction pointer when a section of code ends execution, denoted as value e. This may be accomplished by noting when instructions proceed with linearly progressing memory addresses, and identifying the end pointer value e when there is a large change between two successive instruction addresses. The output of the hardware block 302 may thus be a sequence of instruction pointer pairs (s, e) providing raw event information about the section of code.

In hardware block 304, instruction segments may be compared against a set of instruction parameters to filter out instruction segments that do not meet certain requirements, outputting the start and end point value pairs of only those instructions segments that meet the filter requirements. For example, the hardware may pass along the start and end point value pairs of instruction segments that meet requirements, such as instruction segment size or location in memory, transitions between user space and libraries, repetition of portions of instruction segments, etc. In various embodiments, such filter parameters may be set prior to, during, or after tracking of hardware instruction pointer values and the identification of instruction segments. In various embodiments, the instruction parameters may be provided as feedback from a software program requesting execution of the instructions. For example, filter parameters may be stored in a portion of memory coupled to the hardware block 304, and the hardware block may include circuitry for performing comparisons to the start and end point value pairs as part of filtering operations.

A hardware block 306 may be configured to evaluate the filtered subset of start and end point value pairs of instruction segments. This evaluation may be performed in circuitry that utilizes non-linear filters or approximate quantile sketches to summarize the past history of features of the instruction segments. The output of the hardware block 306 may be features passed to a software application along with an interrupt or trigger to inform the software that instruction segment features are available for analyses. The software may use the instruction segment features to train behavior classifier models, and to analyze patterns of instruction segments for benign or malicious behavior as described herein.

In various embodiments, the circuitry 300 may provide hardware instruction pointer tracking (i.e., counters) tuned to security specific events (e.g., via filtering in block 304) that may provide strong signals of malicious activity. Implementing such instruction pointer tracking and filtering may enable the computing device to reduce the resource overhead of associated software handlers (i.e. classifiers) because such handlers will be triggered only during potentially anomalous behavior by the filtering in hardware blocks 304 and/or 306. The hardware counters extract security specific features for “behavioral” defense against ROP attacks. This approach produces strong, sparse signals that are triggered during ROP attacks but respond infrequently during normal operation so that software handlers working in conjunction to the hardware security counters are called infrequently.

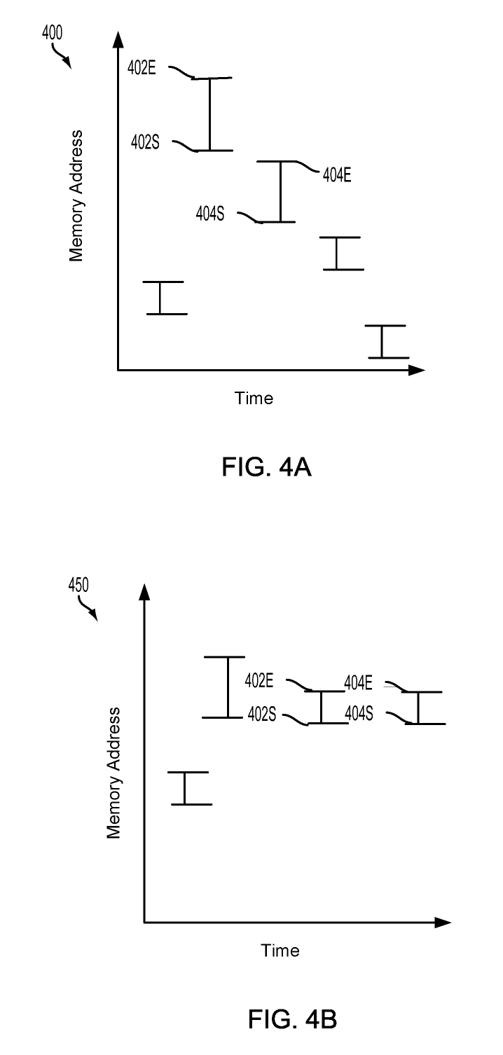

FIG. 4A is a graph 400 illustrating a non-limiting example of benign contiguous instruction segments according to various embodiments. The example of instruction segments is a simplified example for ease of explanation and clarity. This example is not limiting to the various configurations of instruction segments and storage configurations for instruction segments, including, at least, number, format, and/or order of instruction segments, and storage format, order, and/or size/number.

With reference to FIGS. 1-4A, the current value of a hardware instruction pointer may be stored in a memory (e.g., memory 16, 24, and/or private cache 210, 212, 214, 216 and/or shared cache 230). The value of a hardware instruction pointer may be a numerical address in memory where the currently executing instruction is located. Thus, the hardware instruction pointer may indicate the location in memory of an executing instruction. The values (i.e., address in memory) assigned to the instruction pointer as instructions execute may be stored in memory and logged.

Various embodiments may track the changes in hardware instruction pointer values (the memory address to which the hardware instruction pointer points). The computing device may identify contiguous instruction segments by identifying the “start” and “end” of sections of code executed in order. The start of an instruction segment may be the value of the hardware instruction pointer beginning of a set of contiguous instructions. The end may be the value of the hardware instruction pointer at the point at which the instruction pointer jumps to a non-contiguous instruction. Thus, each instruction segment may be represented by a tuple, which may be the start and ending addresses of the instruction segment, a starting address and a length (differential), a length and an ending address, or any other pair of information indicating the size and location of the instruction segment.

The current memory address associated with the hardware instruction pointer may be represented as an appropriate type of integer. The computing device may calculate the difference between one hardware instruction pointer value and the next to determine if the difference is the size of a single instruction. In a typical segment of code, the change in value of the hardware instruction pointer will represent a single instruction difference, corresponding to instructions that are contiguous in memory. If the difference in instruction pointer does not correspond to a single instruction difference, a jump is identified. This process of identifying the end of an instruction segment may be adjusted to account for different size instructions. For example, in some complex instruction set (CISC) processors (e.g. X86), some instructions are longer than others, so a standard instruction set criteria may not be used for recognizing a jump. In such instructions sets, a jump may be recognized when the difference between two instruction sets exceeds a threshold amount that is sufficient to accommodate a long (or the longest) instructions that might be encountered. Other methods for recognizing the end of a contiguous set of instructions may also be implemented.

In normal operating circumstances, such as those of the graph 400, instruction segments identified by the computing device may exhibit overlaps in instruction memory address, or jumps between addresses. For, hardware instruction pointer value jumps may occur during normal operations such as during execution of instruction loops. However, the size of overlapping instruction segments observed during normal operations may be larger than those observed during ROP attacks since loops are likely larger than gadgets. ROP attacks are generally short, while loops may be short or very long. Further, a large number of repetitions may suggest normal behavior. Thus, in order to determine whether jumps in hardware instruction pointer value are caused by an ROP attack, the characteristics of the instruction segments may be analyzed. In various embodiments, the first start 402S and end 402E in a pair of contiguous instruction segments may smoothly transition to the second start 404S and end 404E.

FIG. 4B is a graph 450 illustrating non-limiting examples of malicious contiguous instruction segments according to various embodiments. The following examples of malicious instruction segments may relate to the example shown in FIG. 4A. The following examples of malicious instruction segments are simplified examples for the sake of ease of explanation and clarity. These examples are not limiting to the various types of malicious instruction segments that may be computed, nor to various embodiments that are included in computing the various types of instruction segments.

The example illustrated in FIG. 4B may apply to various instruction segments. In return oriented programming schemes, multiple small sets of instruction segments may be executed, and may include jumps in between the memory address of instructions. During an ROP attack, valid segments of instructions are executed, but they are chained together in an artificial manner in order to implement malicious activity. When instructions are executed in this manner, the instruction segments resulting from an analysis may appear as a number of small instruction segments that make jumps in memory addresses. These jumps may result in overlap in the memory address of instructions within instruction segments, such that the same memory address is utilized more than once. These jumps may also result in large changes in the hardware instruction pointer value between executing instructions. For example, FIG. 4B illustrates the first start 402S and end 402E of the first instruction segment in a contiguous pair of instruction segments may overlap the second start 04S and end 404E of the second instruction segment.

In order to assess the relevance of the hardware instruction pointer jumps, the hardware may evaluate a number of instruction parameters. Passing the hardware instruction pointer directly to a software application may result in processing inefficiencies. Such inefficiencies may be reduced by receiving feedback from the operating system or other software application regarding the instruction parameters that may assist in evaluating the relevance of identified instruction segments. The hardware of the computing device may analyze the memory addresses of the different instances of the hardware instruction pointer to determine whether the utilized addresses are consistent with shared instruction libraries or whether the addresses of the instructions represent user space. The instruction parameters may thus include transitions between user spaces and libraries, The instruction parameters are not processor dependent and may be changed by the operating system or other software application in order to adapt to evolving ROP attacks.

In order to determine whether the patterns exhibited by the instruction segments represent malicious behavior, the operating system or other software application may analyze the information provided by hardware after the instruction segments are selected or dropped using the instruction parameters, and the selected subset is filtered to extract feature information. The hardware of the computing device may identify the start and end of instruction segments by calculating the changes in hardware instruction pointer values and designating every jump as the end and start of two contiguous instruction segments. The computing device may then determine the events that are relevant based on application of instruction parameters and stored thresholds to the identified instruction segments. Instruction parameters may include the length of instruction segments, such as the number of instructions in the segment or the change in value of memory address between the start and end of the segment. Instruction parameters may include the range of memory addresses between two instruction segments. The length of time between two instruction segments may also be considered. Instruction parameters may include whether the instructions in a segment fall within a known range, such as that of an instruction library. Similarly, software specific ranges of relevant memory addresses (user space) may be considered as instruction parameters. Such parameters may include or exclude memory addresses that fall within ranges specific to an executing software application. Events that are deemed to be irrelevant based, at least in part, on the software application's activities may be dropped or removed from consideration.

Once the relevant instruction segments are identified, the computing device may execute one or more filtering functions in order to extract historical behavior information from the time series of instruction segments. The extracted features may be passed to the software application for pattern analysis in order to determine whether the pattern of instruction segment features indicates the presence of malicious behavior.

In various embodiments, either the hardware or the software may generate behavior vectors for each instruction segment. The behavior vectors may be vectors of elements representing features such as the length, location, time sequence, etc. of an instruction segment. The execution characteristics of each software application may dictate which features are extracted and placed in the behavior vectors. For example, detection of ROP attacks in some software applications may require assessing the length between the start and end memory address of instructions within an instruction segment, while other software applications may require determining the size between jumps to detect ROP attacks.

In various embodiments, the computing device hardware may constantly, continuously, or sporadically monitor changes in the hardware instruction contiguous segments (start, end). In other embodiments, the further analysis of monitored events may be initiated by a trigger event occurrence. For example, the detection by the hardware of a high density of short length instruction segments may cause the hardware to trigger an analysis of patterns of monitored instruction segments. Similarly, certain regions of memory may be “flagged” or “caution” zones and the occurrence of jumps to that region may trigger ROP attack detection. The occurrence of trigger events may cause the hardware to provide an interrupt that wakes up the software by requesting instruction segment parameters to be used in pattern analysis.

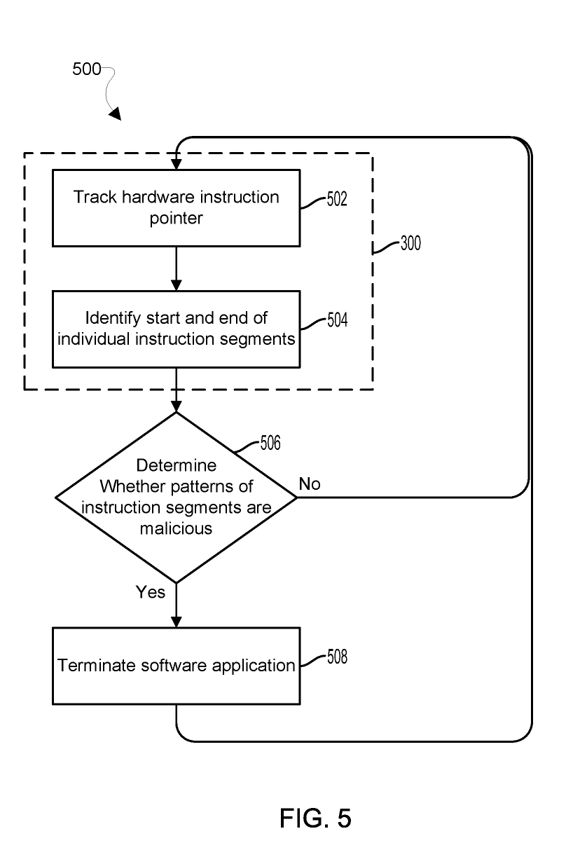

FIG. 5 illustrates a method 500 for implementing programmable hardware security counters to an embodiment. With reference to FIGS. 1-5, the method 500 may be implemented in a computing device in software executing in a processor (e.g., the processor 14 in FIGS. 1 and 2), in general purpose hardware, in dedicated hardware, or in a combination of a processor and dedicated hardware, such as a processor executing software. In order to encompass the alternative configurations enabled in the various embodiments, the hardware implementing the method 500 is referred to herein as a “computing device.”

In block 502, the hardware (e.g., the circuitry 300) of the computing device may track the value of a hardware instruction pointer. A location in memory may be reserved for the current position of the hardware instruction pointer. The computing device may log the changing values of the integer strings associated with the hardware instruction pointer.

In block 504, the hardware (e.g., the circuitry 300) may identify a start and end of contiguous instruction segments using the tracked instruction pointer.

In determination block 506, the computing device may determine whether patterns of the instruction segments output by the hardware represent malicious behavior based, at least in part, on the identified start and end of the instruction segments. The computing device may generate behavior vectors containing the features of any relevant instruction segments and may input them to classifier models to determine whether the features derived from the sequence of instruction segment represents malicious behavior.

In response to determining that the instruction segments represent malicious behavior (i.e., determination block 506=“Yes”), the computing device may terminate execution of a software application in block 508.

In response to determining that the features derived from the contiguous instruction segments do not represent malicious behavior (i.e., determination block 506=“No”), the computing device may return to tracking the hardware instruction pointer in block 502. Thus, the computing device may continue the monitoring and analysis of the hardware instruction pointer without taking further action.

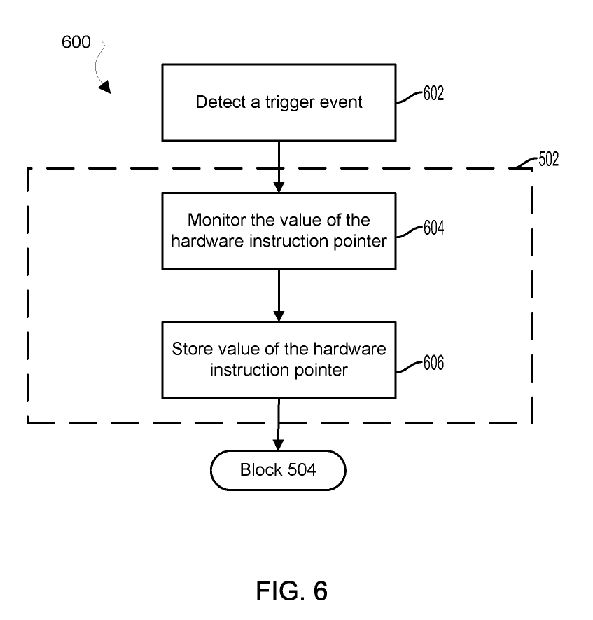

FIG. 6 illustrates a method 600 for tracking a hardware instruction pointer as in block 502 of FIG. 5, according to an embodiment. With reference to FIGS. 1-6, the method 600 may be implemented in circuitry (e.g., 300).

In block 602, the computing device may detect an occurrence of a trigger event. In such embodiments, the computing device may track a hardware instruction pointer in response to detecting the occurrence of the trigger event.

In block 604, the computing device may monitor the value of the hardware instruction pointer for a period of time. In some embodiments, the method 600 may be imitated in response to the occurrence of a trigger event.

In block 606, the computing device may store the value of the instruction pointer for the period of time. For example, the computing device may observe the change in values of the hardware instruction pointer between an initial start time and an end time.

Each value assigned to the hardware instruction pointer (i.e., each memory address) may be logged in memory for use in later analysis. The computing device may then return to block 504 and continue executing method 500 as described.

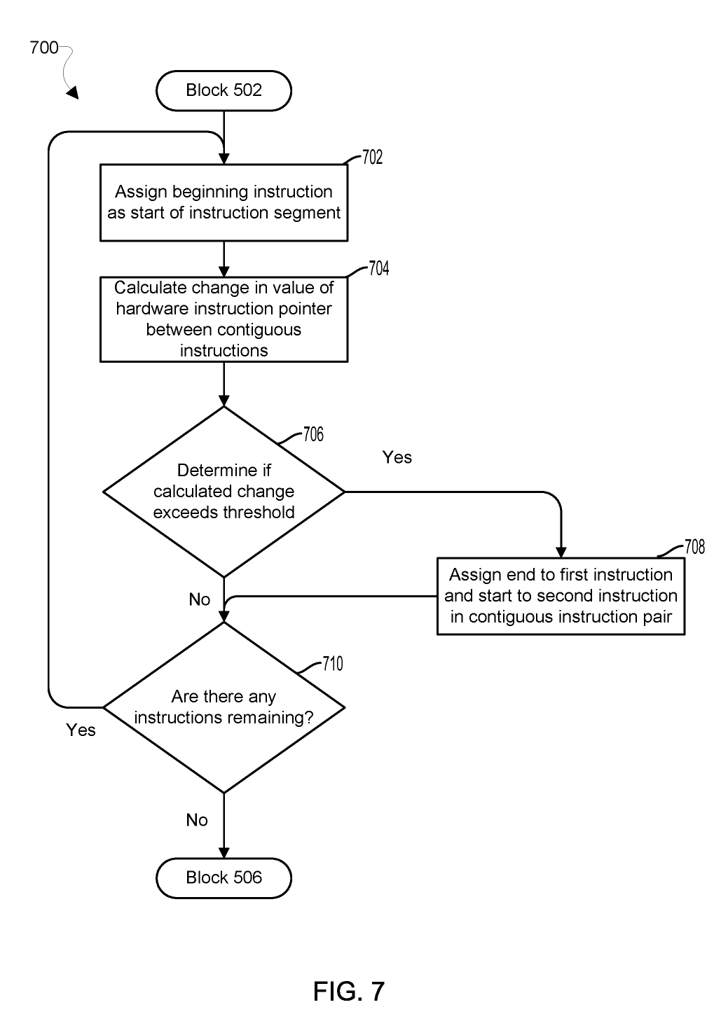

FIG. 7 illustrates a method 700 for identifying contiguous instruction segments as in block 504 of FIG. 5, according to some embodiments. With reference to FIGS. 1-7 method 700 may be implemented in circuitry (e.g., 300).

In block 702, the computing device assigns a beginning instruction as the start of an contiguous instruction segment. The first value in a set of stored hardware instruction pointer values may be assigned the “start” of the first instruction segment.

In block 704, the computing device may calculate a change in the value of the hardware instruction pointer between contiguous instructions. The computing device may iteratively walk through the stored values associated with the hardware instruction pointer, calculating the difference in value between each contiguous pair.

In determination block 706, the computing device may determine whether the calculated change exceeds a threshold. For each contiguous pair of values, the computing device may compare the difference to a threshold value. In this manner, the computing device may detect jumps between instructions by detecting large changes in the memory address associated with an executing instruction.

In response to determining that the calculated change exceeds the threshold (i.e., determination block 706=“Yes”), the computing device may assign the first instruction of the contiguous instructions as the end of a contiguous instruction segment and the second instruction of the contiguous instructions as the start of a contiguous instruction segment in block 708. If the computing device detects a jump, it will denote the first value in the contiguous pair as the end of the prior instruction segment. The second value of the contiguous pair may be denoted as the start of the next instruction segment.

Either in response to determining that the calculated change does not exceed the threshold (i.e., determination block 706=“No”) or proceeding from block 708, the computing device may determine whether there are any instructions remaining for analysis in determination block 710. For example, the computing device may review the hardware instruction pointer logs for a given time period and may determine whether any values remain within the log, for which a difference has not yet been calculated.

In response to determining that there are any instructions remaining for analysis (i.e., determination block 710=“Yes”), the computing device may return to block 704 and continue calculating changes in instruction pointer value.

In response to determining that there are not any instructions remaining for analysis (i.e., determination block 710=“No”), the computing device may proceed to block 506.

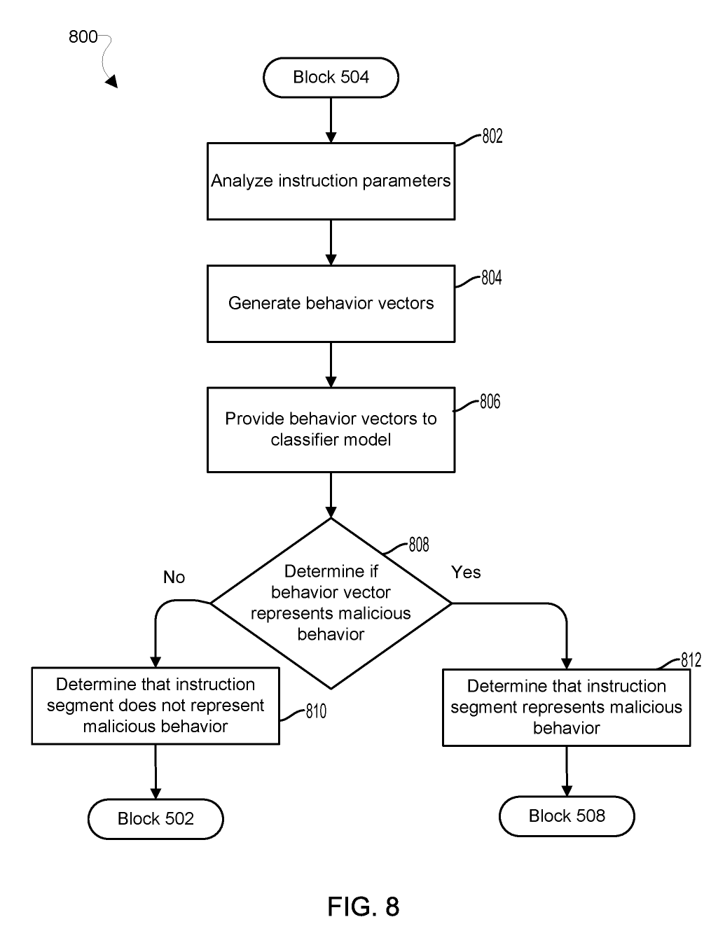

FIG. 8 illustrates a method 800 for determining whether instruction segments represent malicious behavior as in block 506 of FIG. 5, according to an embodiment. With reference to FIGS. 1-8, the method 800 may be implemented in a computing device in software executing in a processor (e.g., the processor 14), in general purpose hardware, in dedicated hardware, or in a combination of a processor and dedicated hardware, such as a processor executing software.

In block 802, the computing device may analyze instruction parameters of the contiguous instruction segments. The computing device may select one or more instruction parameters as dictated by the software application calling the instruction or by the operating system. The computing device may review the identified instruction segments in light of the instruction parameters. For example, an instruction parameter of “instruction segment length” may be used to filter out instruction segments that do not meet the length requirements. In another example, the memory address ranges of each instruction segment may be analyzed to determine whether the address ranges fall within a target memory address range. Any instruction segments that do not contain memory addresses within the target range may be discarded.

In block 804, the computing device may generate a behavior vector based, at least in part, on the analyzed instruction parameters. A behavior vector may be generated for each instruction segment. The behavior vector may be a vector containing elements representing features of the instruction segment. For example, the length, address range, start and end address, time sequence, and other features may be included in the behavior vector.

In block 806, the computing device may provide the generated behavior vector to a classifier model. In some embodiments, the classifier models may be application-specific or behavior-specific models. The behavior vector may be compared to the classifier model to produce a difference vector representing the differences between the behavior vector and the classifier model.

In determination block 808, the computing device may determine based, at least in part on the comparison, whether the behavior vector represents malicious behavior. The difference vector produced during the comparison of the behavior vector to the classifier model may indicate whether the behavior vector exhibits behaviors different enough from the ideal operation represented by the classifier model to indicate malicious behavior.

In response to determining that the behavior vector represents malicious behavior (i.e., determination block 808=“Yes”), the computing device may determine that the instruction segments do represent malicious behavior in block 812. The computing device may then proceed to block 508.

In response to determining that the behavior vector does not represent malicious behavior (i.e., determination block 808=“No”), the computing device may determine that the code executing the instruction segments does not represent malicious behavior in block 810. Thus, if the behavior vector is deemed to represent malicious behavior, the associated patterns of instruction segment also represents malicious behavior. The computing device may repeat the operations of the method 500 by returning to block 502.

In some embodiments, the computing device may further determine whether the instruction parameters meet a parameter threshold. In response to determining that the instruction parameters do not meet the parameter threshold, the computing device may determine that the patterns of instruction segments are not malicious. The computing device may repeat the operations of the method 500 by returning to block 502. In such embodiments, the determination of whether the instruction parameters meet the parameter threshold may be carried out after block 802 prior to, during, or after generation of the behavior vectors.

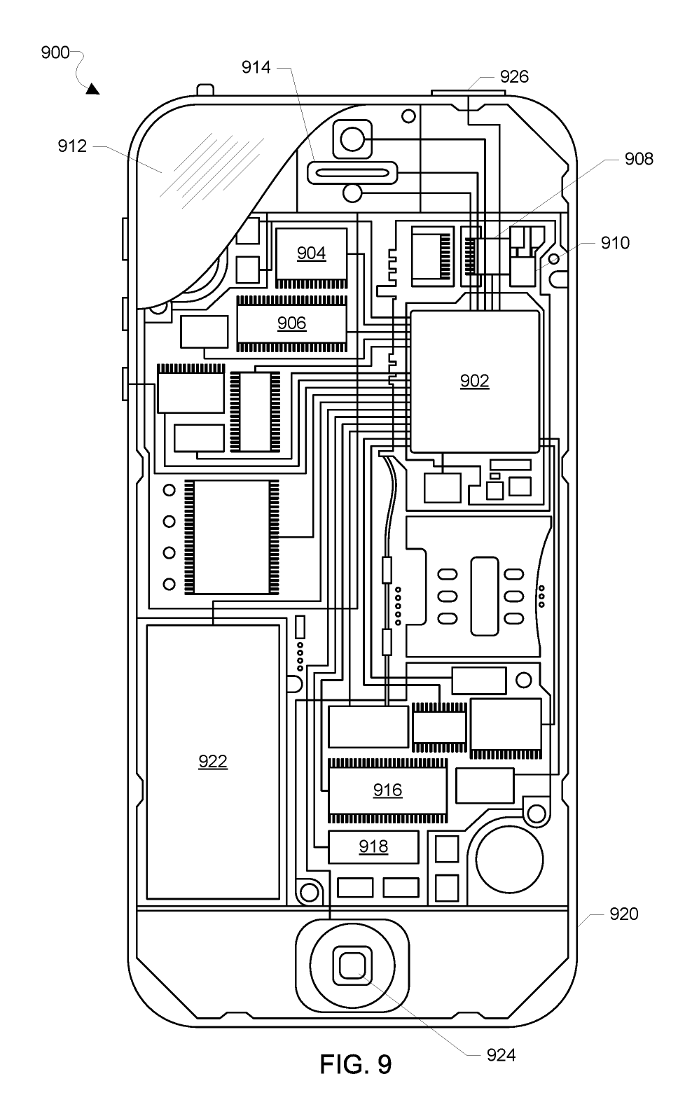

Various embodiments (including, but not limited to, embodiments described above with reference to FIGS. 1-8) may be implemented in a wide variety of computing systems including mobile computing devices, an example of which suitable for use with various embodiments is illustrated in FIG. 9. The mobile computing device 900 may include a processor 902 coupled to a touchscreen controller 904 and an internal memory 906. The processor 902 may be one or more multicore integrated circuits designated for general or specific processing tasks. The internal memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the computing device 900 need not have touch screen capability.

The mobile computing device 900 may have one or more radio signal transceivers 908 (e.g., Peanut, Bluetooth, Zigbee, Wi-Fi, RF radio) and antennae 910, for sending and receiving communications, coupled to each other and/or to the processor 902. The transceivers 908 and antennae 910 may be used with the above-mentioned circuitry to implement the various wireless transmission protocol stacks and interfaces. The mobile computing device 900 may include a cellular network wireless modem chip 916 that enables communication via a cellular network and is coupled to the processor.

The mobile computing device 900 may include a peripheral device connection interface 918 coupled to the processor 902. The peripheral device connection interface 918 may be singularly configured to accept one type of connection, or may be configured to accept various types of physical and communication connections, common or proprietary, such as universal serial bus (USB), FireWire, Thunderbolt, or PCIe. The peripheral device connection interface 918 may also be coupled to a similarly configured peripheral device connection port (not shown).

The mobile computing device 900 may also include speakers 914 for providing audio outputs. The mobile computing device 900 may also include a housing 920, constructed of a plastic, metal, or a combination of materials, for containing all or some of the components described herein. The mobile computing device 900 may include a power source 922 coupled to the processor 902, such as a disposable or rechargeable battery. The rechargeable battery may also be coupled to the peripheral device connection port to receive a charging current from a source external to the mobile computing device 900. The mobile computing device 900 may also include a physical button 924 for receiving user inputs. The mobile computing device 900 may also include a power button 926 for turning the mobile computing device 900 on and off.

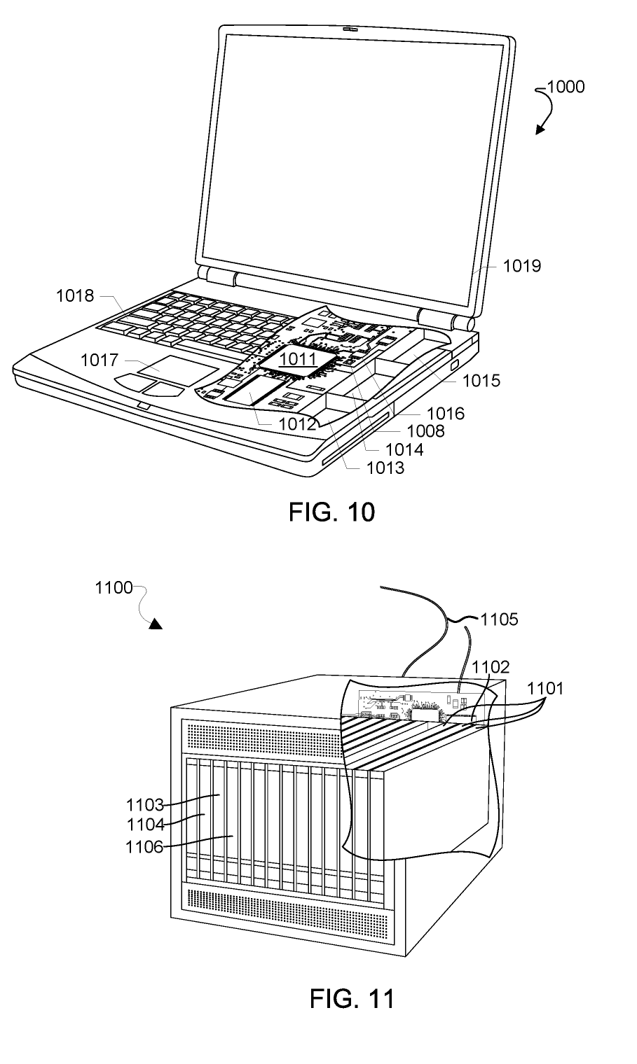

Various embodiments (including, but not limited to, embodiments described above with reference to FIGS. 1-8) may be implemented in a wide variety of computing systems that may include a laptop computer 1000 an example of which is illustrated in FIG. 10. Many laptop computers include a touchpad touch surface 1017 that serves as the computer's pointing device, and thus may receive drag, scroll, and flick gestures similar to those implemented on computing devices equipped with a touch screen display and described above. A laptop computer 1000 will typically include a processor 1011 coupled to volatile memory 1012 and a large capacity nonvolatile memory, such as a disk drive 1013 of Flash memory. Additionally, the computer 1000 may have one or more antenna 1008 for sending and receiving electromagnetic radiation that may be connected to a wireless data link and/or cellular telephone transceiver 1016 coupled to the processor 1011. The computer 1000 may also include a floppy disc drive 1014 and a compact disc (CD) drive 1015 coupled to the processor 1011. In a notebook configuration, the computer housing may include the touchpad 1017, the keyboard 1018, and the display 1019 all coupled to the processor 1011. Other configurations of the computing device may include a computer mouse or trackball coupled to the processor (e.g., via a USB input) as are well known, which may also be used in conjunction with various embodiments.

Various embodiments (including, but not limited to, embodiments described above with reference to FIGS. 1-8) may also be implemented in fixed computing systems, such as any of a variety of commercially available servers. An example server 1100 is illustrated in FIG. 11. Such a server 1100 typically includes one or more multi-core processor assemblies 1101 coupled to volatile memory 1102 and a large capacity nonvolatile memory, such as a disk drive 1104. As illustrated in FIG. 11, multi-core processor assemblies 1101 may be added to the server 1100 by inserting them into the racks of the assembly. The server 1100 may also include a floppy disc drive, compact disc (CD) or digital versatile disc (DVD) disc drive 1106 coupled to the processor 1101. The server 1100 may also include network access ports 1103 coupled to the multi-core processor assemblies 1101 for establishing network interface connections with a network 1105, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), Electrically Erasable Programmable Read-Only Memory (EEPROM), FLASH memory, compact disc (CD)-ROM or other optical disk storage, magnetic disk storage or other magnetic storage devices, or any other medium that may be used to store desired program code in the form of instructions or data structures and that may be accessed by a computer. Disk and disc, as used herein, includes CD, laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method of detecting malicious behavior in a computing device, comprising:
tracking a value of an instruction pointer;
identifying a start and end of contiguous instruction segments using tracked values of the instruction pointer;
determining whether patterns of the instruction segments represent malicious behavior based, at least in part, on the identified start and end of the instruction segments; and
terminating execution of an application in response to determining that the patterns of the instruction segments represent malicious behavior.

2. The method of claim 1, wherein tracking the value of the instruction pointer is performed in response to detecting an occurrence of a trigger event.

3. The method of claim 1, wherein identifying the start and the end of the contiguous instruction segments using tracked values of the instruction pointer comprises:
storing an instruction pointer value of a beginning instruction as the start of a contiguous instruction segment;
calculating a change in the value of the instruction pointer between contiguous instructions;
determining whether the calculated change exceeds a threshold; and
storing an instruction pointer value of a last instruction prior to the calculated change exceeding the threshold as an end of the contiguous instruction segment and storing the instruction pointer value after the calculated change exceeding the threshold as a start of another contiguous instruction segment in response to determining that the calculated change exceeds the threshold.

4. The method of claim 3, wherein the method is repeated until all contiguous instruction segments within a period of time are identified.

5. The method of claim 1, wherein determining whether the instruction segments represent malicious behavior based, at least in part, on the identified start and end of the instruction segments comprises:
analyzing instruction parameters of the contiguous instruction segments;
generating a behavior vector based, at least in part on, the analyzed instruction parameters;
providing the generated behavior vector to a classifier model;
determining based, at least in part, on a result of the classifier model whether the behavior vector represents malicious behavior; and
determining that the patterns of the instruction segments represent malicious behavior in response to determining that the behavior vector represents malicious behavior.

6. The method of claim 5, further comprising:
determining whether one or more of the instruction parameters meet a parameter threshold; and
determining that the patterns of the instruction segments do not represent malicious behavior in response to determining that none of the instruction parameters meet the parameter threshold.

7. The method of claim 5, wherein the instruction parameters include a length of contiguous instruction segments.

8. The method of claim 5, wherein the instruction parameters include a transition of register addresses of instructions within each instruction segment.

9. The method of claim 8, wherein the instruction parameters include the transition of register addresses of instructions within each instruction segment between user code and a library.

10. The method of claim 1, wherein the operations of tracking the value of the instruction pointer and identifying the start and end of contiguous instruction segments using tracked values of the instruction pointer are performed within a hardware component.

11. A hardware module implemented within a computing device, comprising:
an instruction pointer tracking circuit configured to obtain a value of a instruction pointer of a processor;
an analysis circuit configured to receive the value of the instruction pointer and identify a start and end of contiguous instruction segments using values of the instruction pointer and output the start and end values of the instruction pointer for instruction segments;
a buffer circuit; and
a filter circuit configured to receive the start and end values of the instruction pointer for instruction segments, apply filter criteria to the start and end values, and output to the buffer circuit any start and end values of the instruction pointer for instruction segments that satisfy the filter criteria,
wherein the buffer circuit is configured to signal the processor when filtered start and end values of the instruction pointer for instruction segments are available for analysis.

12. A processor, comprising:
a hardware module comprising:
an instruction pointer tracking circuit configured to obtain a value of an instruction pointer of the processor;
an analysis circuit configured to receive the value of the instruction pointer and identify a start and end of contiguous instruction segments using values of the instruction pointer, and output the start and end values of the instruction pointer for instruction segments;
a buffer circuit; and
a filter circuit configured to receive the start and end values of the instruction pointer for instruction segments, apply filter criteria to the start and end values, and output to the buffer circuit any start and end values of the instruction pointer for instruction segments that satisfy the filter criteria,
wherein the buffer circuit is configured to signal the processor when filtered start and end values of the instruction pointer for instruction segments are available for analysis, and
wherein the processor is configured to:
analyze the filtered start and end values of the instruction pointer to determine whether patterns of the instruction segments represent malicious behavior based, at least in part, on the filtered start and the end of the instruction segments; and
terminate execution of an application in response to determining that the patterns of the instruction segments represent malicious behavior.

13. The processor of claim 12, wherein the instruction pointer tracking circuit is configured to obtain the value of the instruction pointer of the processor in response to detecting an occurrence of a trigger event.

14. The processor of claim 12, wherein the analysis circuit is configured to receive the value of the instruction pointer and identify a start and end of contiguous instruction segments using the values of the instruction pointer, and output to the buffer circuit any start and end values of the instruction pointer for instruction segments that satisfy the filter criteria by:
storing an instruction pointer value of a beginning instruction as the start of a contiguous instruction segment;
calculating a change in the value of the instruction pointer between contiguous instructions;
determining whether the calculated change exceeds a threshold; and
storing an instruction pointer value of a last instruction prior to the calculated change exceeding the threshold as an end of the contiguous instruction segment and storing the instruction pointer value after the calculated change exceeding the threshold as a start of another contiguous instruction segment in response to determining that the calculated change exceeds the threshold.

15. The processor of claim 12, wherein the processor is further configured to determine whether the instruction segments represent malicious behavior based, at least in part, on the identified start and end of the instruction segments by:
analyzing instruction parameters of the contiguous instruction segments;
generating a behavior vector based, at least in part on, the analyzed instruction parameters;
providing the generated behavior vector to a classifier model;
determining based, at least in part, on a result of the classifier model whether the behavior vector represents malicious behavior; and
determining that the patterns of the instruction segments represent malicious behavior in response to determining that the behavior vector represents malicious behavior.

16. The processor of claim 15, wherein the processor is further configured to:
determine whether one or more of the instruction parameters meet a parameter threshold; and
determine that the patterns of the instruction segments do not represent malicious behavior in response to determining that none of the instruction parameters meet the parameter threshold.

17. The processor of claim 15, wherein the instruction parameters include a length of contiguous instruction segments.

18. The processor of claim 15, wherein the instruction parameters include a transition of register addresses of instructions within each instruction segment.

19. The processor of claim 18, wherein the instruction parameters include transition of register addresses of instructions within each instruction segment between user code and a library.

20. A non-transitory processor-readable storage medium having stored thereon processor-executable instructions configured to cause a processor to perform operations comprising:
identifying a start and end of contiguous instruction segments using tracked values of an instruction pointer;
determining whether patterns of instruction segments represent malicious behavior based, at least in part, on the identified start and end of the instruction segments; and
terminating execution of an application in response to determining that the patterns of the instruction segments represent malicious behavior.

21. The non-transitory processor-readable storage medium of claim 20, wherein the stored processor-executable instructions are configured to cause the processor to perform operations such that identifying a start and end of contiguous instruction segments using tracked values of the instruction pointer is performed in response to detecting an occurrence of a trigger event.

22. The non-transitory processor-readable storage medium of claim 20, wherein the stored processor-executable instructions are configured to cause the processor to perform operations such that identifying the start and the end of the contiguous instruction segments using tracked values of the instruction pointer comprises:
storing an instruction pointer value of a beginning instruction as the start of a contiguous instruction segment;
calculating a change in the instruction pointer value between contiguous instructions;
determining whether the calculated change exceeds a threshold; and
storing an instruction pointer value of a last instruction prior to the calculated change exceeding the threshold as an end of the contiguous instruction segment and storing the instruction pointer value after the calculated change exceeding the threshold as a start of another contiguous instruction segment in response to determining that the calculated change exceeds the threshold.

23. The non-transitory processor-readable storage medium of claim 20, wherein the stored processor-executable instructions are configured to cause the processor to perform operations such that determining whether the instruction segments represent malicious behavior based, at least in part, on the identified start and end of the instruction segments comprises:
analyzing instruction parameters of the contiguous instruction segments;
generating a behavior vector based, at least in part on, the analyzed instruction parameters;
providing the generated behavior vector to a classifier model;
determining based, at least in part, on a result of the classifier model whether the behavior vector represents malicious behavior; and
determining that the patterns of the instruction segments represent malicious behavior in response to determining that the behavior vector represents malicious behavior.

24. The non-transitory processor-readable storage medium of claim 23, wherein the stored processor-executable instructions are configured to cause the processor to perform operations further comprising:
determining whether one or more of the instruction parameters meet a parameter threshold; and
determining that the patterns of the instruction segments do not represent malicious behavior in response to determining that none of the instruction parameters meet the parameter threshold.

25. The non-transitory processor-readable storage medium of claim 23, wherein the stored processor-executable instructions are configured to cause the processor to perform operations such that the instruction parameters include a length of contiguous instruction segments.

26. The non-transitory processor-readable storage medium of claim 23, wherein the stored processor-executable instructions are configured to cause the processor to perform operations such that the instruction parameters include a transition of register addresses of instructions within each instruction segment.

27. The non-transitory processor-readable storage medium of claim 26, wherein the stored processor-executable instructions are configured to cause the processor to perform operations such that the instruction parameters include transition of register addresses of instructions within each instruction segment between user code and a library.
